(19) United States
(12) Patent Application Publication
(10) Pub. No.: US 2006/0284599 A1
(43) Pub. Date: Dec. 21, 2006

(54) CHARGING MODE CONTROL CIRCUIT AND METHOD

(76) Inventors: Kuan-Hong Hsieh, Shenzhen (CN); Han-Che Wang, Shenzhen (CN); Shin-Hong Chung, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,006

(22) Filed: Jun. 7, 2006

(30) Foreign Application Priority Data
Jun. 17, 2005 (CN) 200510035397.9

(51) Int. Cl. H02J 7/00

(52) U.S. Cl. 320/128

(57) ABSTRACT

The present invention provides a charging mode control circuit and method. By utilizing such charging mode control circuit and method, a secondary battery fixed in a portable device can be quickly charged when the portable device communicate with an external computer. The method includes the steps of: a) providing a commutator, the commutator comprising an adapter, a first interface, and a second interface, wherein the first interface is connected to the external computer and the second interface is connected to the portable device; b) filtering a charging voltage from the adapter and obtaining a ripple voltage from the charging power supply; c) rectifying the ripple voltage; d) comparing the rectified ripple voltage with a reference voltage, thereby producing a voltage waveform according to a comparison result; and e) selecting a fast charging mode on the secondary battery according to the voltage waveform.

### TECHNICAL FIELD

The present invention relates to a charging mode control circuit and method, particularly to a charging mode control circuit and method used in a portable device.

### GENERAL BACKGROUND

Portable devices with Universal Serial Bus (USB) interfaces such as portable computers are welcomed by users for their small size and convenient usage. At present there are generally two solutions for charging a secondary battery equipped in a portable device.

One of the solution is shown in FIG. 1 where a portable device 11 is connected with a computer 2 via their USB interfaces (i.e., USB interface 113 and USB interface 121). According to the protocol standards of USB 1.1 and USB 2.0, the maximum power transmitted by USB interfaces is 2.5 watt (0.5 A @ 5V), in other words, the computer supplies no more than 500 mA charging current under the charging voltage of +5V. Given these circumstances, a secondary battery 111 fixed within the portable device 11 can obtain a charging current from the computer 12 while in-link with the computer, however this charging current is rather small and the charging speed is rather slow.

Another solution is shown in FIG. 2, a portable device 21 is connected to a mains supply 24 via an alternating current to direct current converter (AC/DC) adapter 22. The portable device 21 and the AC/DC adapter 22 both have a USB interface (i.e., USB interface 213 and USB interface 221) for inter-connecting each other. A secondary battery 211 fixed within the portable device 21 obtains a charging current from a mains supply 24 after the AC/DC adapter 22 performs the voltage transformation. By using such a charging means, a secondary battery 211 fixed within the portable device 21 can obtain a fairly bigger current resulting to a quicker charging speed, however, the portable device will not be able to communicate with a computer when the battery 211 is charging.

Accordingly, it would be advantageous if the secondary battery fixed in the portable device can obtain a charging current with a fairly faster speed without terminating the data transmission between the computer and the portable device.

### SUMMARY

A charging mode control method is provided. The method is for charging a secondary battery fixed in a portable device during the same time period of data communication with an external computer. The method includes the steps of:a) providing a commutator, the commutator comprising an adapter, a first interface, and a second interface, wherein the first interface is connected to the external computer and the second interface is connected to the portable device; b) filtering a charging voltage from the adapter and obtaining a ripple voltage from the charging power supply; c) rectifying the ripple voltage; d) comparing the rectified ripple voltage with a reference voltage, thereby producing a voltage waveform according to a comparison result; and e) selecting a fast charging mode on the secondary battery according to the voltage waveform.

Another charging mode control method is provided. The method is for charging a secondary battery fixed in a portable device during the same time period of data communication with an external computer. The method includes the steps of: a) connecting the portable to the external computer with their own USB interfaces; b) filtering a charging voltage from the external computer and obtaining a ripple voltage; c) rectifying the ripple voltage; d) comparing the rectified ripple voltage with a reference voltage, thereby producing a continuous low voltage level waveform according to a comparison result; and e) selecting a slow-charging mode on the secondary battery according to the continuous low voltage level waveform.

A portable device can communicate with an external computer and obtain a charging voltage from a charging power supply is further provided. The portable device includes: a high pass filtering circuit for filtering a charging voltage and obtaining ripple voltages from the charging voltage; a rectification circuit for rectifying the ripple voltages from the high pass filtering circuit; a voltage comparing circuit having two inputs that receives the rectified ripple voltage and a reference voltage respectively, and an output which outputs a voltage waveform according to a comparison result of the rectified ripple voltage and the reference voltage; and a charging control circuit for selecting a corresponding charging mode on the secondary battery according to the voltage waveform from the voltage comparing circuit, the charging control circuit having two inputs and an output. One input receives the voltage waveform from the voltage comparison circuit and the other input receives the charging voltage and an output transmits a selective charging current to the secondary battery according to the selected charging mode.

A commutator for connecting a portable device and a computer is provided. The commutator includes an adapter for obtaining a charging voltage from a mains supply, the AC/DC adapter having a VCC (power) line and a GND (Ground) line; a first interface for connecting an external computer and transmitting data from the external computer, the first interface having a VCC pin, a GND pin, and a plurality of data pins; and a second interface for connecting the adapter and the portable device, the second interface having a VCC pin, a GND pin, and a plurality of data pins; wherein the GND pin and the data pins of the second interface respectively connect to the GND pin and the data pins of the first interface, and the GND pin and the VCC pin of the second interface further connect to the GND line and the VCC line of the adapter respectively.

Based on the present invention, the secondary battery can be charged in a fast-charging mode by inserting the commutator which includes the AC/DC adapter therein between the computer and the portable device. The AC/DC adapter provides a relatively large current for the charging mode control circuit, which makes it feasible to charge the secondary battery fixed within the portable device quickly during data transmission with an external computer.

### BRIEF DESCRIPTION OF DRAWINGS

FIG. 1 is a block diagram of an exemplary application of prior charging means;

FIG. 2 is a block diagram of another exemplary application of prior charging means;

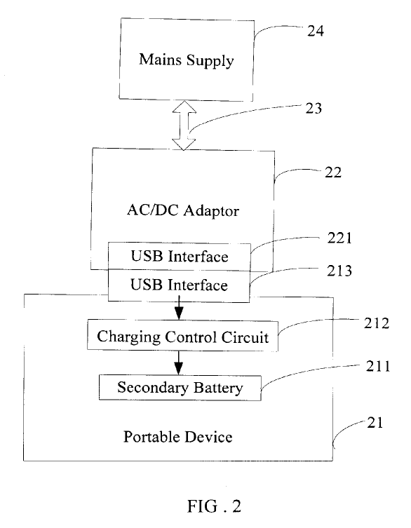

FIG. 3 is a block diagram of an exemplary application of charging mode control circuit and method in accordance with a preferred embodiment of the present invention; and

FIG. 4 depicts details of an exemplary charging mode control circuit.

### DETAILED DESCRIPTION

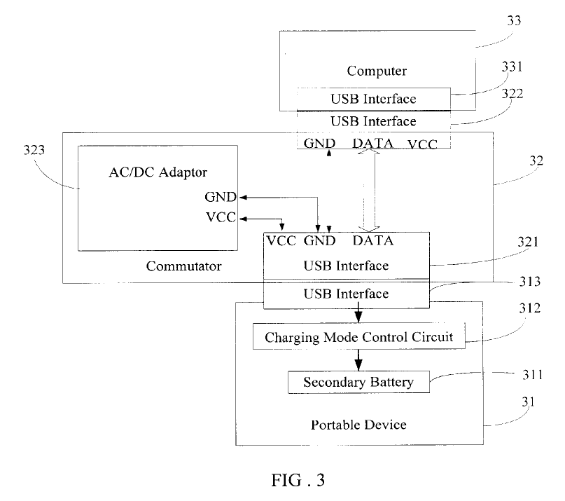

FIG. 3 is a block diagram of an exemplary application of a charging mode control circuit and method in accordance with a preferred embodiment of the present invention. Shown here are a portable device 31, a commutator 32, and a computer 33. The portable device 31 has a charging mode control circuit 312 incorporated therein and a secondary battery 311 fixed therein. The charging mode control circuit 312 is used to select a selective charging mode on the secondary battery 311 according to a particular charging power supply available.

The commutator 32 includes an adapter 323 and two USB interfaces 321 and 322. The USB interface 321 is connected directly to the USB interface 313 of the portable device 31 and the USB interface 322 is connected directly to the USB interface 322 of the computer 33. Each of the USB interfaces 321 and 322 has a VCC (power) pin, a GND (ground) pin, and a plurality of DATA pins. The AC/DC adapter 323 has a VCC line and a GND line. The VCC pin and the GND pin of the USB interface 321 are respectively connected to the VCC line and the GND line of the AC/DC adapter 323, thereby obtaining a charging power supply from an external power supply (not shown) via the AC/DC adapter 323. Furthermore, the GND pin and DATA pins of the USB interface 321 are respectively connected to the GND pin and DATA pins of the USB interface 322, thereby communicating with the computer 33 when the USB interface 322 is connected to a USB interface 331 of the computer 33. The VCC pin of the USB interface 322 is kept idle.

Thus, by utilizing such connections, the portable device 30 not only can quickly obtain the charging power supply with a fairly great current (larger than 500 mA) from the external mains supply, but can also perform data communications with the computer 33. During this charging process, the charging mode control circuit 31 2 chooses a rapid charging mode on the secondary battery 311.

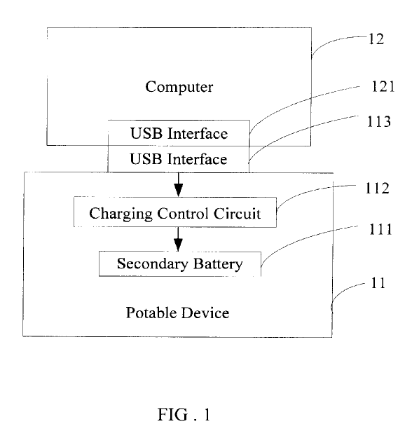

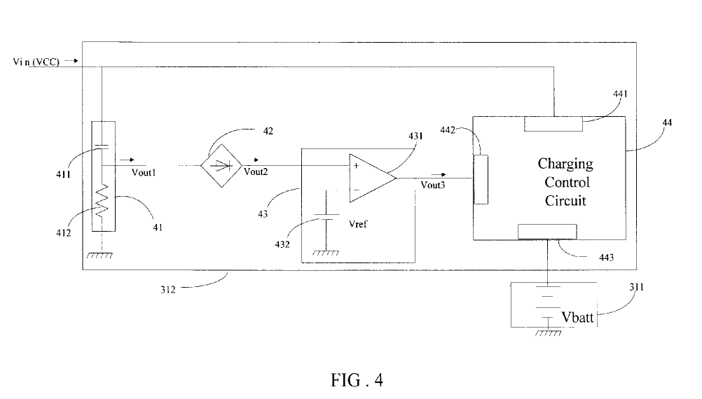

FIG. 3 shows the charging mode of the secondary battery 311 obtaining a large charging current (referred to as “a fast-charging mode”). If the portable device 11 is associated with the computer 12 via their own USB interfaces (i.e., USB interface 313 and USB interface 331) similar to FIG. 1, the secondary battery 311 obtains a small charging current (referred to as “a slow-charging mode”) to FIG. 1 too. The two charging modes both support data communication between the portable device 31 and the computer 33 while the secondary battery 311 is charging. The schematic diagram of the charging mode control circuit 312 selecting a selective charging mode on the secondary battery 311 is depicted in detail in FIG. 4.

FIG. 4 depicts details of an exemplary charging mode control circuit. Shown here are a charging mode control circuit 312 and a secondary battery 311. The charging mode control circuit 312 mainly includes a high pass filtering circuit 41, a rectification circuit 42, a voltage comparing circuit 43, and a charging control circuit 44.

The high pass filtering circuit 41 receives a charging voltage Vin(VCC), (including direct voltage, low frequency alternating voltages, and high frequency alternating voltages) from an external power supply (e.g., a computer or a mains supply), and filters out the direct voltage and low frequency alternating voltages therein, thereby obtaining the high frequency alternating voltages (referred to as “ripple voltage Vout1”). Further, the ripple voltage Vout1 is a resultant voltage from a plural of voltages with various amplitudes. The amplitudes of the plural of voltages are different due to different external power supplies. Therefore, the ripple voltage Vout1 has different amplitudes in regards to the different external power supplies. For example, if the external power supply is the mains supply, the amplitude of the maximum voltage Vm1 of the ripple voltage Vout1 is equal to or more than 700 mV; alternatively, if the external power supply is the computer 33, the amplitude of the maximum voltage Vm2 of the ripple voltage Vout1 is less than 700 mV.

The rectification circuit 42 receives the ripple voltage Vout1 from the high pass filtering circuit 41, and rectifies the ripple voltage Vout1 thereto. The rectification circuit 42 can be a half-bridge rectification circuit or a full-bridge rectification circuit. Furthermore, the rectification elements thereof adopt either Silicon diodes or Germanium diodes with different forward-voltage drop. For simplicity, in such case, the rectification elements adopt Germanium diodes with a 300 mV forward-voltage drop. Therefore, the rectification circuit 42 is capable of decreasing the ripple voltage Vout1 thereto by 300 mV. Accordingly, under the rectification of the rectification circuit 42, the voltage whose amplitude is larger than 300 mV can be rectified to a voltage whose amplitude is larger than 0 mV, contrary, the voltage whose amplitudes is equal to or less than 300 mV can be rectified to 0 mV. So, the amplitude of the maximum voltage Vm1 of the ripple voltage Vout1 from the mains supply such as, for example, 700 mV, is decreased to 400 mV; and the amplitude of the maximum voltage Vm2 of the ripple voltage Vout1 from the computer such as, for example, less than 500 mV, is decreased to 200 mV.

The voltage comparing circuit 43 has a voltage comparator 431 and a reference voltage supply 432. The voltage comparator 431 has two inputs and an output. A first input of the voltage comparator 431 connects to the rectification circuit 42 for obtaining the rectified voltage Vout2. A second input of the voltage comparator 431 connects to the reference voltage supply 432 for obtaining a reference voltage Vref. The voltage comparator 431 compares the rectified voltage Vout2 with the reference voltage Vref, and produces a selective voltage waveform Vout3 to the charging control circuit 44.

The reference voltage Vref can be set according to the rectified voltage Vout2, that is, the reference voltage Vref is in a range from Vm1 to Vm2. For example, supposing Vm1 is 500 mV and Vm2 is 100 mV, for simplicity, the reference voltage Vref is set to 300 mV. Given these circumstances, if the rectified voltage Vout2 is rectified from the mains supply, the voltage waveform Vout3 is a rectangular-wave; if the Vout2 is rectified from the computer, the voltage waveform Vout3 is a continuous low voltage level waveform.

The charging control circuit 44 identifies the charging power supply according to the voltage waveform Vout3 from the voltage comparator 43, and selects a selective charging mode on charging the secondary battery 311. The charging control circuit 44 further has two inputs (symbolically expressed as 441 and 442) and an output (symbolically expressed as 443). Input 441 receives the voltage Vin(VCC) from the VCC pin of the USB interface 313, and input 442 receives the charging control waveform Vout3 from the output of the voltage comparator 431. The output 443 is used to output the selective charging current for the secondary battery 311.

For example, if the voltage waveform Vout3 is the continuous low voltage level waveform, the charging control circuit 44 selects the slow-charging mode on the secondary battery 311 with a relative small charging current between 0 mA and 500 mA; if voltage waveform Vout3 is the rectangle-wave, the charging control circuit 42 selects the fast-charging mode on the secondary battery 311 with a relative large charging current between 0 mA and 1000 mA.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A charging mode control method for charging a secondary battery fixed in a portable device during data communication with an external computer, the method comprising the steps of:
providing a commutator, the commutator comprising an adapter providing a charging voltage, a first interface, and a second interface, wherein the first interface is connected to the external computer and the second interface is connected to the portable device;
filtering the charging voltage provided by the adapter and obtaining a ripple voltage;
rectifying the ripple voltage; comparing the rectified ripple voltage with a reference voltage, thereby producing a voltage waveform according to a comparison result; and
selecting a fast-charging mode on the secondary battery according to the voltage waveform.

2. The charging mode control method according to claim 1, the charging voltage from the adapter comprises a direct current component, a high frequency alternating current component, and a low frequency alternating current component.

3. The charging mode control method according to claim 2, the direct current component and the low frequency alternating current component are filtered out by a filtering circuit while the high frequency alternating current component is reserved and is referred as the ripple voltage.

4. A charging mode control method for charging a secondary battery fixed in a portable device at the same time of data communication with an external computer, the method comprising the steps of:
connecting the portable device to the external computer with USB interfaces;
filtering a charging voltage from the external computer and obtaining a ripple voltage;
rectifying the ripple voltage;
comparing the rectified ripple voltage with a reference voltage, thereby producing a continuous low voltage level waveform according to a comparison result; and
selecting a slow-charging mode on the secondary battery according to the continuous low voltage level waveform.

5. The charging mode control method according to claim 4, the charging voltage from the adapter comprises a direct current component, a high frequency alternating current component, and a low frequency alternating current component.

6. The charging mode control method according to claim 5, the direct current component and the low frequency alternating current component are filtered out by a filtering circuit while the high frequency alternating current component is reserved and is referred as the ripple voltage.

7. A portable device communicating with an external computer and obtaining a charging voltage from a charging power supply, the portable device comprising a charging mode control circuit for selecting a charging mode on a secondary battery according to a voltage waveform, the charging mode control circuit comprising:
a high pass filtering circuit for filtering a charging voltage and obtaining a ripple voltage from the charging voltage;
a rectification circuit for rectifying the ripple voltage from the high pass filtering circuit;
a voltage comparing circuit having two inputs and an output, wherein one of the two inputs receives the rectified ripple voltage and the other of the two inputs receives a reference voltage, and the output of the voltage comparing circuit outputs a voltage waveform according to a comparison result between the rectified ripple voltage and the reference voltage; and
a charging control circuit for selecting a corresponding charging mode on the secondary battery according to the voltage waveform provided by the voltage comparing circuit, the charging control circuit having two inputs and an output, wherein one of the two inputs of the voltage comparing circuit receives the voltage waveform provided by the voltage comparison circuit, the other of the two inputs of the voltage comparing circuit receives the charging voltage, and the output of the charging control circuit transmits a selective charging current to the secondary battery according to the selected charging mode.

8. The portable device according to claim 7, wherein the charging voltage is selected from the group consisting of a voltage provided by an adapter and a voltage provided by an external computer.

9. The portable device according to claim 7, wherein the charging voltage comprises a direct current component, a high frequency alternating current component, and a low frequency alternating current component.

10. The portable device according to claim 9, wherein the direct current component and the low frequency alternating current component are filtered out by a filtering circuit while the high frequency alternating current component is reserved and is referred to as the ripple voltage.

11. The portable device according to claim 7, wherein the voltage waveform is selected from the group consisting of a rectangle-waveform and a continuous low voltage level waveform.

12. The portable device according to claim 7, wherein the charging control circuit selects a slow-charging mode if the voltage waveform is the continuous low voltage level waveform, and selects a fast-charging mode if the voltage waveform is the rectangle-waveform.

13. The portable device according to claim 7, wherein the range of the charging current is determined by the selected charging mode.

14. The portable device according to claim 13, wherein the charging current is in a range between 0 mA and 500 mA in the slow-charging mode, and the charging current is in a range between 0 mA and 1000 mA in the fast-charging mode.

15. A commutator for connecting a portable device and a computer, by which a secondary battery fixed in the portable device is charged at the same time of communicating with the computer, the commutator comprising:
an adapter for obtaining a charging voltage from a mains supply, the adapter having a VCC line and a GND line;
a first interface for connecting an external computer and obtaining data from the external computer, the first interface having a VCC pin, a GND pin, and a plurality of DATA pins; and
a second interface for connecting the adapter and the portable device, the second interface having a VCC pin, a GND pin, and a plurality of DATA pins; wherein:
the GND pin and the DATA pins of the second interface are respectively connected to the GND pin and the DATA pins of the first interface, and the GND pin and the VCC pin of the second interface further are respectively connected to the GND line and the VCC line of the adapter.

16. The commutator according to claim 15, wherein the VCC pin of the first interface is kept idle.

17. The commutator according to claim 15, wherein the first interface and the second interface are USB interfaces.
